(19) United States
(12) Patent Application Publication
(10) Pub. No.: US 2018/0335559 A1
(43) Pub. Date: Nov. 22, 2018

(54) BACKLIGHT UNIT AND LUMINOUS FLUX CONTROL MEMBER FOR LOCAL DIMMING

(71) Applicant: SEOHAN LITEK CO., LTD., Seoul (KR)

(72) Inventor: Seongik CHO, Osan (KR)

(21) Appl. No.: 15/952,642

(22) Filed: Apr. 13, 2018

Related U.S. Application Data
(63) Continuation of application No. PCT/KR2018/002492, filed on Feb. 2, 2018.

(30) Foreign Application Priority Data
May 17, 2017 (KR) 10-2017-0060902
Jun. 13, 2017 (KR) 10-2017-0073905

(51) Int. Cl. F21V 8/00

(52) U.S. Cl. CPC G02B 6/0038; G02B 6/0053; G02B 6/0091; G02B 6/0016; G02B 6/0036; G02B 6/0055

(57) ABSTRACT

A backlight unit is disclosed which is capable of diffusing light emitted from a light source uniformly and suppressing white spot phenomenon. The backlight unit includes a light guide panel having a first surface and a second surface opposite to the first surface, a concaved light receiving region formed on the first surface, a light intensity adjusting recess formed on the second surface, a light intensity adjusting sheet disposed on the light intensity adjusting recess and the second surface around the light intensity adjusting recess. The backlight unit includes a substrate on which a plurality of light emitting devices are disposed, a plurality of luminous flux control members which are disposed on the substrate corresponding to the light emitting devices such that the light from the light source is uniformly transmitted upward, and a shade layer which is disposed between the luminous flux control members to reflect a portion of the light emitted through the luminous flux control member.

### CROSS-REFERENCE TO RELATED APPLICATIONS

This application is a continuation of International Application No. PCT/KR2018/002492 filed Feb. 2, 2018, which claims the benefit of Korean Patent Application No. 10-2017-0060902 filed May 17, 2017 and Korean Patent Application No. 10-2017-0073905 filed Jun. 13, 2017, each of which is expressly incorporated by reference herein in its entirety as if each were incorporated by reference herein individually.

### BACKGROUND

### 1. Field

The inventive concept relates to a backlight unit and a luminous flux control member for local dimming, and more specifically, to a backlight unit and a luminous flux control member for local dimming with wide light diffusion range.

### 2. Description of Related Art

In different to OLEDs capable of self-emitting, a display such as an LED incapable of self-emitting receives light using a backlight unit which is located behind the backside of the display.

The backlight units using LEDs are classified into an edge type and a direct type in accordance with mounting position of the LED light sources.

The direct type backlight unit includes a reflect sheet disposed on a substrate such as a PCB on which a plurality of LEDs arrays having a plurality of LEDs, and a light guiding member, a diffusion sheet, a prism sheet and a protection sheet are sequentially disposed on the light reflect sheet. The substrate such as a PCB, the reflect sheet, the light guide member, the diffusion sheet, the prism sheet and the protection sheet are fixed by a mold frame which functions as a case.

The direct type backlight unit has advantages of elevating display resolution and efficiency of power consumption simultaneously because the led array is installed under the light guide member to accomplish local dimming by light irradiation regions of display region of the LCD.

Since the LED is, however, located directly under the light irradiation region of the display of the LCD of the direct type backlight unit, it is brighter than other region where the LED is located in the light irradiation region, in other words, white-spot phenomenon is occurred. Thus, for sufficiently uniform spreading of the light emitted from the LED over the light irradiation region and suppressing the white-spot phenomenon, the direct type backlight unit has a design limitation that an air-gab for spreading light is necessary between the LED and the light guide member and the thickness of the light guide member should be enlarged uniformly over the light irradiation region.

Recently, it has been widely researched to improve image quality and color gamut of the LCD by modification of the structure and properties of the backlight unit. Especially, for obtaining high contrast ratio, a local dimming method is applied to selectively adjust the bright. When the light source of the backlight unit illuminates on a plurality of sectional regions independently or implements the local dimming in which a plurality of the light sources is controlled by sectional regions, it is necessary that light on each region is uniform and amount of light interfering an adjacent region is minimized.

### SUMMARY

The inventive concept provides a luminous flux control member which can spreads light around the light axis of a light source to suppress the white-spot phenomenon and improves partially light extracting ability to suppress shadow-ring phenomenon.

The inventive concept provides a luminous flux control member and a backlight unit for local dimming which can minimize or reduces amount of light interfering adjacent regions.

The inventive concept provides a luminous flux control member and a backlight unit which can local dimming and uniformly spreads light emitted from a light source to suppress white-spot phenomenon.

In order to solve the technical problem, the inventive concept provides a backlight unit which spreads light emitted from the light source and minimizes amount of light interfering adjacent region. The backlight unit includes a substrate on which a plurality of light emitting devices are disposed, a plurality of luminous flux control members which are disposed on the substrate corresponding to the light emitting devices such that the light from the light source is uniformly transmitted upward, and a shade layer which is disposed between the luminous flux control members to reflect a portion of the light emitted through the luminous flux control member.

In an embodiment, the shade layer is a partition which is disposed on the substrate to form a plurality of domains, and the luminous flux control member may be disposed in the domain, respectively.

In another embodiment, the luminous flux control member includes a light guide member through which light emitted from the light emitting device is transmitted.

In another embodiment, the shade layer may include a light reflective region where the light emitted from the luminous flux control member is reflected and a transparent region where the light emitted from the luminous flux control member is transmitted to an adjacent luminous flux control member.

In another embodiment, the shade layer may be semi-transparent which reflects a portion of the light emitted from the luminous flux control member and transmits a portion of the light emitted from the luminous flux control member.

In order to solve the technical problem, the inventive concept provides a luminous flux control member which spreads light emitted from the light source and minimizes amount of light interfering adjacent region. The luminous flux control member includes a light guide member which has a first surface with recessed light incident surface on a normal light axis of a light emitting device and a second surface with a recess on the normal light axis of the light emitting device, the second surface is opposite to the first surface, a light intensity adjusting sheet which is formed on the second surface around the recess, and the shade layer which is formed on a side of the light guide member.

In another embodiment, the shade layer may include a reflective region where the light emitted through the light guide member is reflected and a transparent region where the light emitted through light guide member is transmitted to an adjacent luminous flux control member.

In another embodiment, the shade layer may be semi-transparent which reflects a portion of the light emitted through light guide member and transmits a portion of the light emitted through light guide member.

In another embodiment, the side of the light guide member includes a reverse sloped surface, wherein the shade layer is formed on the reverse sloped surface to reflect at least a portion of the light emitted through the light guide member.

### BRIEF DESCRIPTION OF THE DRAWINGS

The inventive concept will become more apparent in view of the attached drawings and accompanying detailed descriptions.

FIG. 1a is a perspective view illustrating a backlight unit according to an embodiment of the inventive concept.

FIG. 1b is a perspective view illustrating a backlight unit according to another embodiment of the inventive concept.

FIGS. 2a through 2c are drawings illustrating a partition on the FIGS. 1a and 1b, respectively.

FIG. 3a is a plan view of a luminous flux control member used for local dimming according to the inventive concept.

FIGS. 3b and 3c are sectional views taken along a line A-A′ of FIG. 3a:

FIG. 4a is a perspective view illustrating a luminous flux control member according to an embodiment of the inventive concept.

FIG. 4b is a sectional view taken along a line A-A′ of FIG. 4a.

FIG. 5 is a perspective view illustrating light spreading in the luminous flux control member according to an embodiment of the inventive concept.

FIGS. 6 through 8 are sectional views illustrating the luminous flux control member according to another embodiment of the inventive concept.

FIG. 9 is a perspective view illustrating a luminous flux control member according to another embodiment of the inventive concept.

FIGS. 10a and 10b are plan views illustrating luminous flux control members arranged in a backlight unit according to the inventive concept, respectively.

FIG. 11a is a perspective view illustrating a luminous flux control member according to another embodiment of the inventive concept.

FIG. 11b is a sectional view taken along a line A-A′ of FIG. 11a:

FIG. 12 is a plan view illustrating a luminous flux control member according to another embodiment of the inventive concept.

FIG. 13 is a sectional view illustrating luminous flux control pattern of a luminous flux control member according to the inventive concept.

FIG. 14a is a plan view illustrating a luminous flux control member according to an embodiment of the inventive concept.

FIG. 14b is a sectional view taken along a line A-A′ of FIG. 14a.

FIG. 15 is a cross sectional view illustrating a light intensity adjusting sheet of the luminous flux control member according to an embodiment of the inventive concept.

FIGS. 16 through 18 are sectional views illustrating the luminous flux control member according to another embodiment of the inventive concept.

FIGS. 19 and 20 are drawings illustrating a method of fabricating a luminous flux control member of FIGS. 17 and 18.

FIG. 21 is a drawing illustrating luminous flux control of the luminous flux control member according to an embodiment of the inventive concept.

FIG. 22 is a drawing illustrating a luminous flux control member according to another embodiment of the inventive concept.

FIGS. 23a and 23b are drawings illustrating modified embodiments of a recess of a second surface of a luminous flux control member according to embodiments of the inventive concept.

FIGS. 24a and 24b are drawings illustrating modified embodiments of a concave of a luminous flux control member according to embodiments of the inventive concept.

FIGS. 25a through 25c are drawings illustrating modified embodiments of a board region of a luminous flux control member according to embodiments of the inventive concept.

FIG. 26 is a drawing illustrating a second surface of a luminous flux control member according to another embodiment of the inventive concept.

### DETAILED DESCRIPTION OF THE EMBODIMENTS

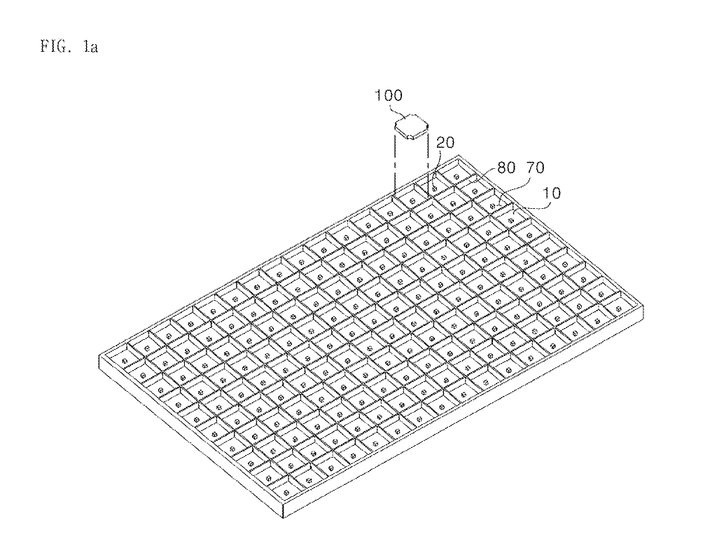

FIG. 1 is a perspective view illustrating a backlight unit according to an embodiment of the inventive concept.

Referring to FIG. 1, the backlight unit may include a frame coupled with a rear surface of a LCD display panel. A substrate with a plurality of light sources 20 is disposed on the frame. Luminous flux control members 100 corresponding to the light sources are disposed on the substrate 10. The luminous flux control members 100 are respectively disposed over the light sources 200 such that light emitted from the light sources is transmitted through the luminous flux control member thereby spreading uniformly over entire surface of the backlight unit.

The substrate 10 is separated into a plurality of domains 70 such that the light sources 20 are disposed on the domains, respectively. A partition 80 is disposed on the substrate 10 to define the domains 70. The luminous flux control member 100 is disposed in each domain defined by the partition 80. The partition 80 controls that light emitted from a side of the luminous flux control member 100 is transmitted to another domain. At least a portion of the light emitted from a side of the luminous flux control member 100 is reflected off the partition 80 without traveling to another domain. The partition 80 acts as a shade layer which prevents or reduces transmission of the light emitted from each domain to another domain. Thus, when a light source disposed in a selected domain is turned on, light is spread over entire of the backlight through the luminous flux control member 100 in the selected domain and light is not emitted through a luminous flux control member 100 in a non-selected domain such that contrast between domains can be increased.

FIG. 1b is a perspective view illustrating a backlight unit according to another embodiment of the inventive concept.

Referring to FIG. 1b, the backlight unit may include a frame which is coupled with a rear surface of a LCD display panel. A substrate 10 with a plurality of light sources 20 is disposed on the frame. Luminous flux control members 200 corresponding to the light sources are disposed on the substrate 10. The luminous flux control member 200 is disposed over the plurality of the light sources 200 such that light emitted from the light sources is transmitted through the luminous flux control member and spread uniformly over entire surface of the backlight unit. For example, a luminous flux control member 200 is disposed over four light sources 20 which are arranged in a matrix on the substrate 10. Without being limited thereto, one luminous flux control member 200 can be disposed over light sources with various number such as two, four or eight, or various arrangements.

The substrate 10 is separated into a plurality of domains 70 such that a plurality of the light sources 20 is disposed on each domain, respectively. A partition 80 is disposed on the substrate 10 to define the domains 70. The luminous flux control member 200 is disposed in each domain defined by the partition 80. The partition 80 controls that light emitted from a side of the luminous flux control member 200 is transmitted to another domain. At least a portion of the light emitted from a side of the luminous flux control member 200 is reflected off the partition 80 without traveling to another domain. The partition 80 acts as a shade layer which prevents or reduces transmission of the light emitted from each domain to another domain. Thus, when a light source disposed in a selected domain is turned on, light is spread over entire of the backlight through the luminous flux control member 200 in the selected domain and light is not emitted through a luminous flux control member 200 in a non-selected domain such that contrast between domains can be improved. According to the embodiment, since a plurality of light sources 10 is disposed on a domain, each light source in the domain is controlled such that sensitive dimming effect can be provided.

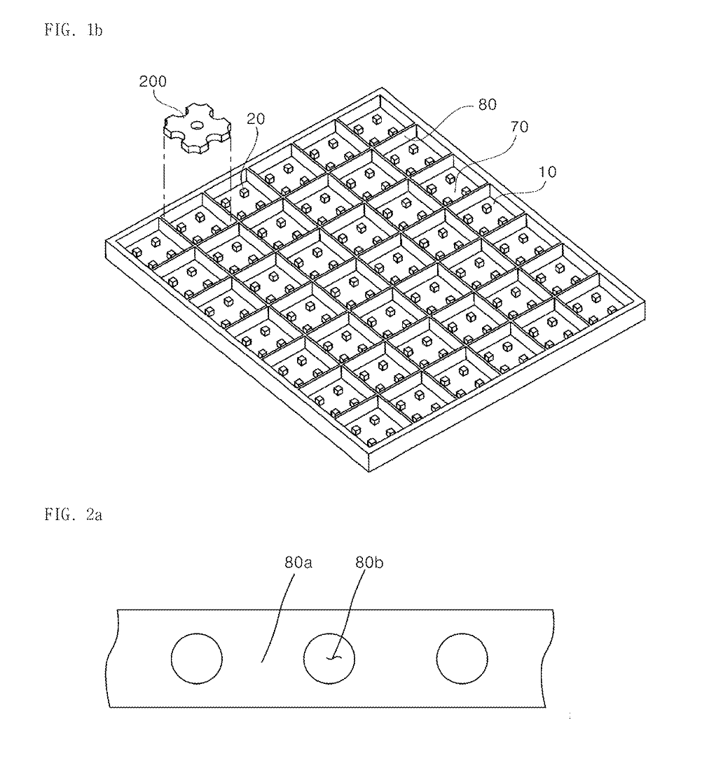

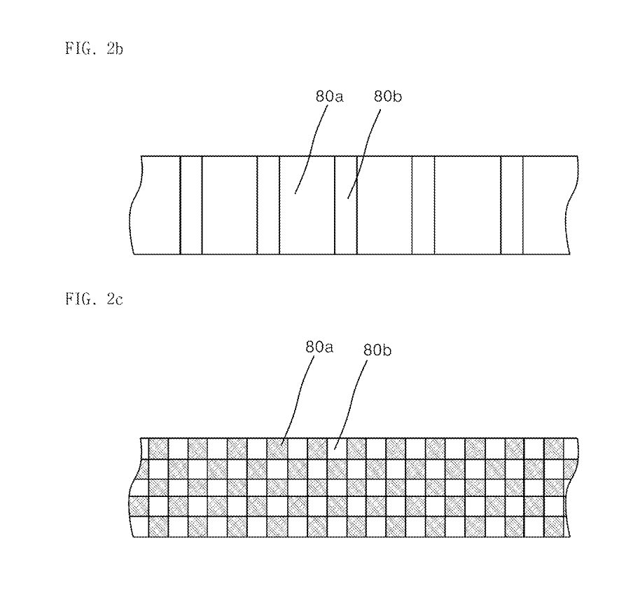

FIGS. 2a through 2b are drawings illustrating the partition on the FIGS. 1a and 1b, respectively.

The partition 80 defining domains in the backlight unit may include a reflective region 80a where light emitted in the domain is reflected and a transparent region 80b where light is transmitted to an adjacent domain.

Referring to FIG. 2a, the reflective region 80a is a part for forming the partition 80 and may be formed of a material which reflects light or has transmission rate under 50%. The transparent region 80b is a part for transmitting light and may be formed of a material which has transmission rate more than 50% or formed by opening the partition 80.

As shown in the drawing, the transparent regions 80b may be formed on the partition at predetermined intervals. The partition 80 may be formed by punching a reflective material, by coating a reflective material on a transparent material, or by co-injecting materials with different transmission rate.

Referring to FIG. 2b, the reflective region 80a and the transparent region 80b may be formed alternately on the partition 80. The transparent region 80b may be formed by punching the partition 80 in slit shape, by coating a reflective material on the partition of a transparent material, or by co-injecting materials with different transmission rate. As shown in FIG. 2a, the reflective region 80a is a part for forming the partition 80 and may be formed of a material which reflects light or has transmission rate under 50%. The transparent region 80b is a part for transmitting light and may be formed of a material which has transmission rate more than 50%.

Referring to FIG. 2c, the reflective region 80a and the transparent region 80b may be formed into a check pattern. The transparent region 80b may be formed by punching the partition 80 in slit shape, by coating a reflective material on the partition of a transparent material, or by co-injecting materials with different transmission rate. As shown in FIG. 2a, the reflective region 80a is a part for forming the partition 80 and may be formed of a material which reflects light or has transmission rate under 50%. The transparent region 80b is a part for transmitting light and may be formed of a material which has transmission rate more than 50%.

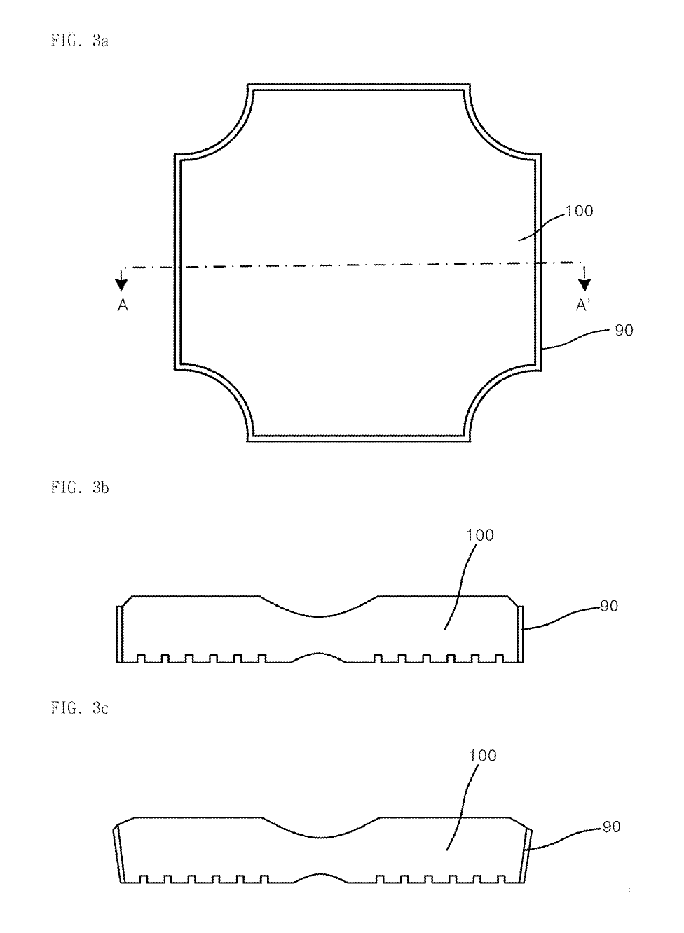

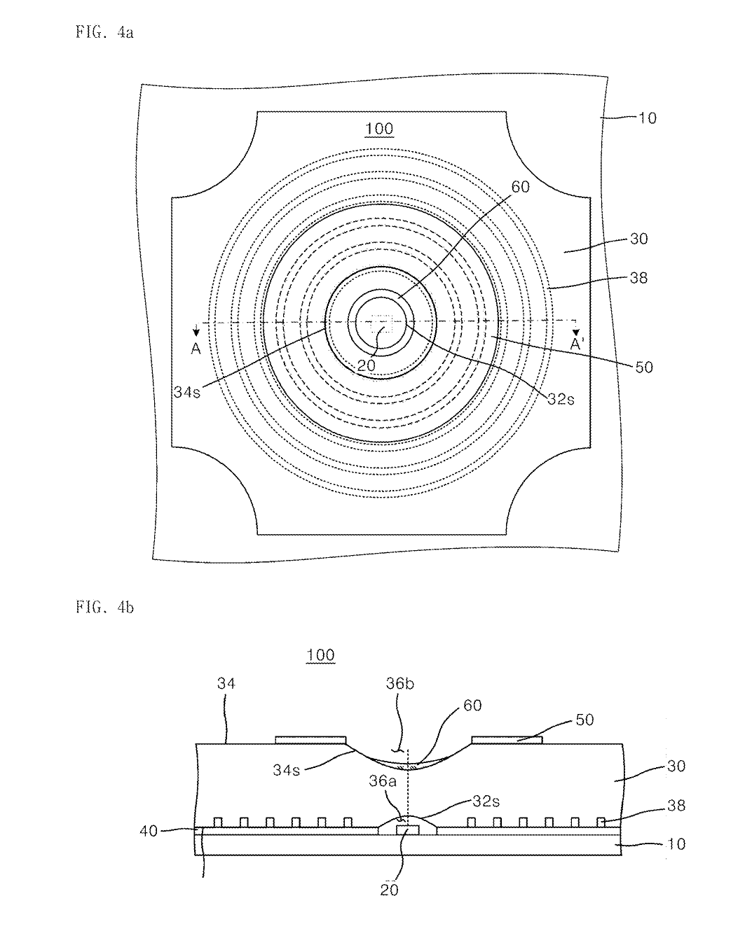

FIG. 3a is a plan view of a luminous flux control member used for local dimming according to the inventive concept, and FIGS. 3b and 3c are sectional views taken along a line A-A′ of FIG. 3a.

The shade layer may be implemented by the partition disposed on the substrate as described above such that domains are defined for the local dimming and traveling of the light emitted in the domain to another domain can be reduced or prevented. The inventive concept, without being limited thereto, provides a structure by which light traveling between domains can be reduced or prevented by using a luminous flux control member disposed in each domain.

Referring to FIGS. 3a and 3b, the luminous flux control member according to inventive concept includes a shade layer 90 reflecting light on a side of the luminous flux control member 100. The luminous flux control member 100 may be, as shown in FIGS. 1a and 1b, disposed over one or a plurality of light sources disposed on the substrate 10 to define domains. The shade layer 90 formed on the side of the luminous flux control member 100 may be act as a partition 80 to reduce or prevent light in the domain from traveling to another domain.

The shade layer may be formed of a structure similar to the partition shown in FIGS. 2a through 2c. That is to say, the shade layer 90 may include a reflective region and transparent region, the transparent region may be windows formed at predetermined intervals, or the reflective regions and the transparent regions are alternately arranged or arranged in a check pattern.

The shade layer 90 may be formed by coating a dye or a paint, or by attaching a film with adhesion on a side of the light guide member composing the luminous flux control member 100, or formed of a plastic material structure which covers an outer wall of the luminous flux control member.

FIG. 3c is a sectional view illustrating a luminous flux control member according to another embodiment of the inventive concept.

Referring to FIG. 3c, the side surface of the luminous flux control member 100 has a reverse bias slop and a shade layer 90 is formed on the side surface. The light arrived to the shade layer through the light guide member can be reflected off a reflective region since shade layer 90 is in contact with the light guide member to face forward. Other elements are the same as the above described in FIG. 3a.

FIG. 4a is a plan view illustrating a luminous flux control member according to an embodiment of the inventive concept and FIG. 4b is a sectional view taken along a line A-A′ of FIG. 4a.

Referring to FIGS. 4a and 4b, the luminous flux control member 100 for a direct type backlight unit according to the inventive concept includes a light guide member 30 which has a first surface 32 with recessed light incident surface 32s on a normal light axis of a light emitting device 20 and a second surface 34 with a recess 36b on the normal light axis of the light emitting device 20 wherein the second surface is opposite to the first surface, and a light intensity adjusting sheet 50 which is formed at least on the second surface 34 around the recess 36b.

An incident concave 36a is formed on the first surface 32. The incident concave 36a is disposed at the light axis and around the light axis, and between the light emitting device and the first surface 32.

A sectional surface of the light incident surface 32s taken along the normal light axis may be parabolic shape or semicircular shape. In addition, the sectional surface has a shape of which tangent around the normal light axis may be increasing in a negative value as getting away from the normal light axis, or the tangent around the normal light axis may be increasing and decreasing to form a convex shape at the center of the incident concave 36a.

A plurality of luminous flux control patterns 38 is formed around the first surface. The luminous flux control patterns 38 are disposed around the normal light axis in a coaxial shape. A cross-section of the luminous flux control patterns 38 may be various shapes such as triangular groove, square groove, arc, arch or parabola and so on. The light flux patterns 38 may not be limited to arrange in coaxial shape but has various shapes such as circular dot, rectangular dot, lattice, net, spiral or textile and so on.

The light guide member 30 may be formed of PMMA (Polymethyl Methacrylate) or PC (Polycarbonate).

For example, the light guide member 30 may be formed of PMMA or PC with at least 90% of transmittance measured by JIS K7361-1 measurement and less than 0.5% of haze measured by JIS K136 measurement.

The light intensity adjusting sheet 50 is formed on the second surface 34 around the recess 36b. The light intensity adjusting sheet 50 may be formed by attaching on the second surface 34 or by coating a paint or a resin. The light intensity adjusting sheet 50 may be formed on the second surface 34 to have an opening where a part of the recess 36b is exposed. An edge region of the light intensity adjusting sheet 50 may have a wave pattern or a jagged pattern which are formed in a curve or a line. The light intensity adjusting sheet 50 may be a semi-transparent material which can transmit a portion of light and may be a transparent matrix in which diffusing particles are dispersed or a transparent sheet which is white color.

The recess 36b may be formed of a light reflective surface 34s. The light reflective surface 34s is a curved surface of which tangent is 0 at the center and increasing as getting away from the center, in a sectional surface along the normal light axis. The recess 36b may include a reflective coating layer 60 on at least a part of the light reflective surface 34s. For example, the reflective coating layer 60 may be formed on the recess adjacent to the normal light axis. A portion of light arrived to the reflective coating layer 60 is transmitted and a portion of the light is reflected off an interface between the reflective coating layer 60 and the reflective surface 34s to return into the light guide member 30.

The luminous flux control member 100 of the inventive concept may be disposed over the substrate 10, and an adhesive layer or adhesive sheet may be interposed between the light guide member 30 and the substrate 10 such that the light guide member 30 and the substrate 10 are coupled.

A light emitting device is mounted on the substrate and the luminous flux control member 100 is disposed on the substrate 10 such that the incident concave 36a is located at the normal light axis of the light emitting device.

It is not limited to adhering or attaching the luminous flux control member 100 on the substrate 10, however, the luminous flux control member 100 can be coupled with the substrate 10 by another fasten device.

The light guide member 30 may have rectangular planar shape and may be a shape of which a part of an edge is partially removed, for example, removed by rectangle or triangle or arc shape.

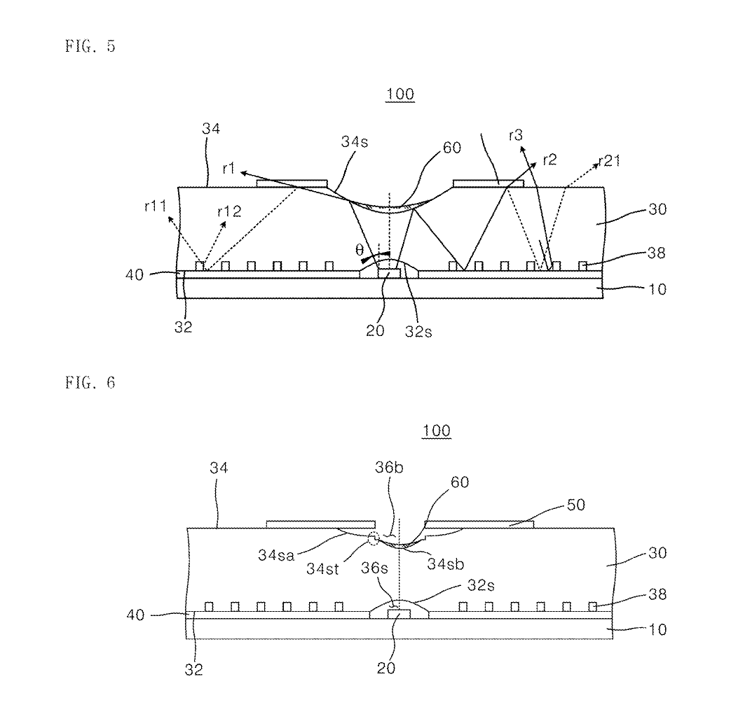

FIG. 5 is a perspective view illustrating light spreading in the luminous flux control member according to an embodiment of the inventive concept.

Referring to FIG. 5, it is under the necessary of occurring white spot since the light emitted from the light emitting device has the maximum intensity of light around the normal light axis. However, according to the inventive concept, a recessed light reflective surface 34s is formed on the first surface around the normal light axis such that the light with high intensity around the light reflective surface is diffused to suppress the white spot occurring.

As shown in a drawing, light r1 emitted from the light emitting device is transmitted into the light guide member 30 through the light incident surface 32s, and a portion of light is reflected off the light reflective surface 34s and emitted to the outside after passing the second surface 34. In order to reflect light emitted from the light emitting device on the light reflective surface 34s totally, angle of an incident light from the normal line of the light reflective surface 34s should be at least the critical angle. When the light from the light emitting device 20 is emitted at an angle of a predetermined angle (θ) and more, light incident angle arrived on the light reflective surface 34s can be at least the critical angle. Therefore, light arrived on the light reflective surface 34s after being emitted at an angle more that the angle (θ) is reflected and emitted to the outside through the second surface 34. In light arrived on the second surface 34, light r11 with incident angle at the critical angle and more is returned to the light guide member 10 and reflected off the first surface 32 thereby emitted to the outside. Since a plurality of luminous flux control pattern 38 is formed on the first surface 32, a portion of light r12 arrived on the first surface 32 may be refracted or reflected off the luminous flux control pattern 38 to be returned into the light guide member 30.

The light intensity adjusting sheet 50 may be formed of a material capable of diffusing and transmitting light such that light traveling in the light intensity adjusting sheet 50 is diffused uniformly to suppress the white spot.

Light emitted at an angle less than the angle (θ) from the light emitting device 20 may be refracted at the light reflective surface 34s and emitted to the outside, and a portion of the light may be returned into the light guide member 30. The reflective coating layer 60 may be selectively formed in order to suppress excessive light emitted to the outside after transmitting the light reflective surface 34s.

Light r2 reflected off the light reflective surface 34s may be returned into the light guide member 30, reflected off the first surface 32, transmitted again in the light guide member 30 and emitted to the outside through the second surface 34. Light which is emitted through the second surface 34 and penetrates the light intensity adjusting sheet 50, is diffused uniformly. Light r21 which was reflected off the second surface 34 is reflected off the first surface 32 and then emitted to the outside after traveling the light guide member 30.

Light traveling in the light guide member 30 is refracted or reflected off the luminous flux control pattern 38 and then emitted to the outside through the second surface to the variety of directions.

According to the inventive concept as described above, a traveling direction of the light from the light emitting device with the maximum intensity of light around the normal light axis is diffused using the luminous flux control member 100 such that the white spot around the normal light axis is suppressed and light can be uniformly emitted to the outside.

FIGS. 6 through 8 are sectional views illustrating the luminous flux control member according to another embodiment of the inventive concept.

Referring to FIG. 6, a recess 36b of the luminous flux control member 100 according to the inventive concept may have a first recess which has a center with a tangent of zero and a curved surface 34sb with a tangent increased as getting away from the center, and a second recess which has a horizontal surface around the first recess, a stepped surface 34st around the horizontal surface and a curved surface 34sa with a tangent increased as getting away from the stepped surface.

The light intensity adjusting sheet 50 is formed on the second surface 34 around the recess 36b. The light intensity adjusting sheet 50 may be extended over the recess 36b to cover a part of the recess 36b.

A reflective coating layer 60 may be formed on the curved surface 34sb of the first recess of the recess 36b. The light intensity adjusting sheet 50 may be extended over the curved surface 34sa of the second recess.

According to the inventive concept, light traveling to the second surface 34 around the normal light axis has large incident angle on the basis of a normal line such that probability of full reflection is high, and light incident to a peripheral second surface has small incident angle on the basis of a normal line thereby refracted a the curved surface 34sa of the second recess and emitted to the outside. In other words, the light around the normal light axis having a high intensity of light is generally returned into the light guide member 30 and diffused, and the peripheral light having a low intensity of light is generally transmitted through the light guide member and emitted to the outside, thereby the light of the light emitting device may be uniformly dispersed. Light which was passed the curved surface 34sa of the second recess may be secondary dispersed while traveling in the light intensity adjusting sheet 50

Referring to FIG. 7, a recess 36b of the luminous flux control member 100 may have a curved surface 34s of which tangent is increasing as approaching the center from an edge and the center is convergent to a light source.

Tangent of the curved surface 34s is large around the normal light axis. The tangent of the curved surface is lower as going to an edge. Thus, light around the normal light axis with high intensity has large incident angle on the basis of a normal line such that probability of full reflection is high, and the incident angle is lower as going to an edgy such that the probability of the full reflection is lower. Therefore, the intensity of light around the normal light axis is dispersed such that the white spot can be suppressed. In order to uniformly disperse light which passes the recess 34b, a reflective coating layer 60 may be included on the curved surface 34s.

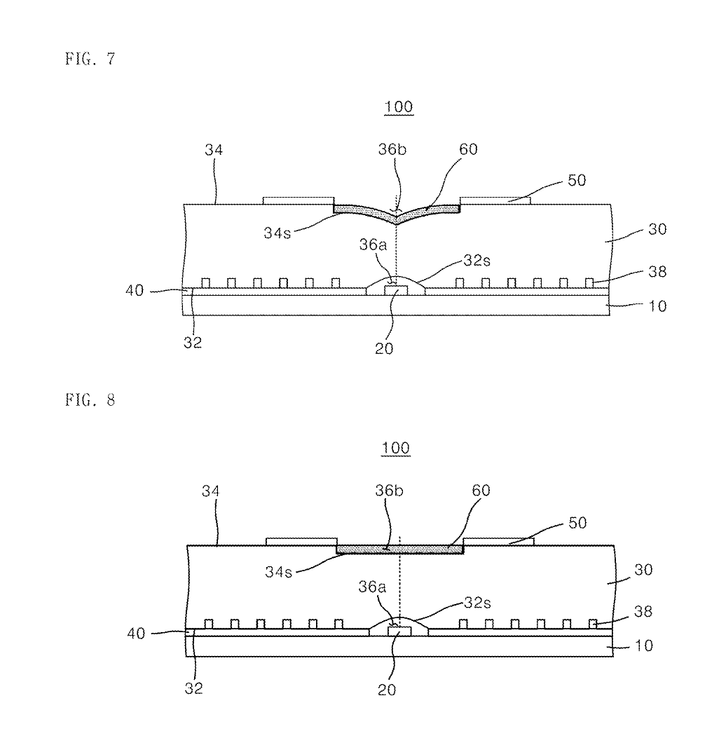

Referring to FIG. 8, a recess 36b of the luminous flux control member 100 according to the inventive concept may have a light reflective surface 34s which includes two sidewalls in a sectional view along the normal light axis and a horizontal surface between the both sidewalls. A reflective coating layer 60 may be disposed on the light reflective surface 34s such that light with high intensity around the normal light axis can be returned into the light reflective surface 30 and diffused.

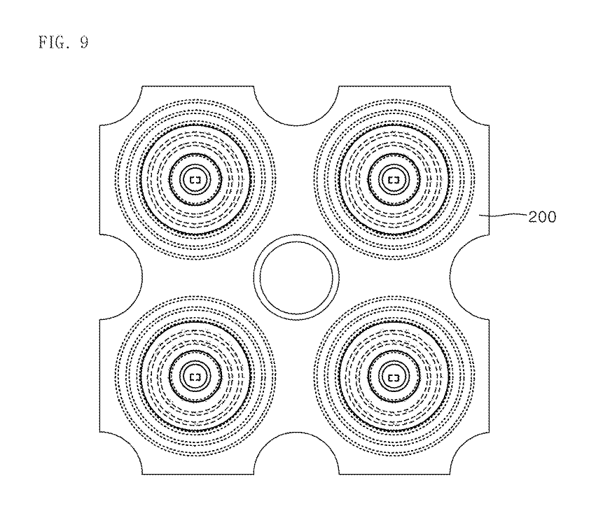

FIG. 9 is a plan view illustrating a luminous flux control member according to another embodiment of the inventive concept.

The luminous flux control member 100 according to the inventive concept may be a symmetric structure with respect to a normal light axis, as shown in FIGS. 4a and 4b. In other words, a luminous flux control member is disposed on a light emitting device to disperse light uniformly.

Referring to FIG. 9, the luminous flux control member according to the inventive concept may be a structure in which a luminous flux control member is disposed on a plurality of light emitting devices. For example, the structure may be four luminous flux control members in FIGS. 4a and 4b which are coupled. However, it is not limited thereto, the luminous flux control member 200 according to the inventive concept may be a structure in which the variety numbers of the structures in FIGS. 4a and 4b such as two, three, six or eight are coupled, those are arranged in breadth and height as or in line as shown in FIG. 9.

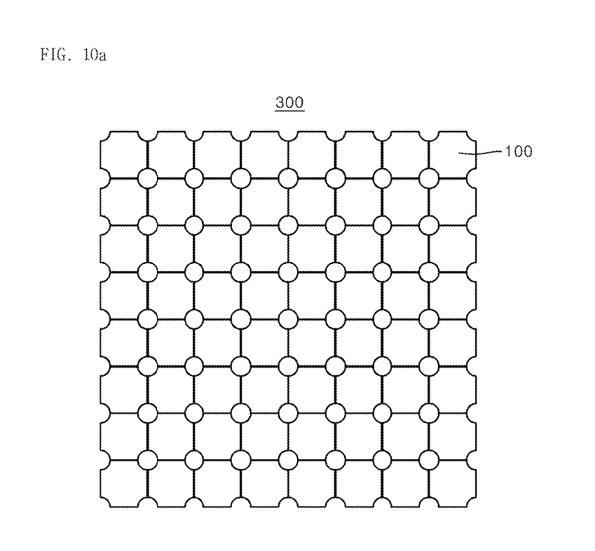

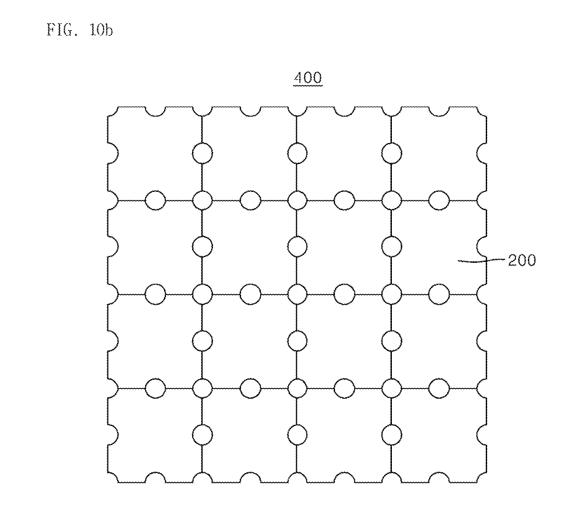

FIGS. 10a and 10b are plan views illustrating luminous flux control members arranged in a backlight unit according to the inventive concept, respectively.

Referring to FIGS. 10a and 10b, the backlight units 300 and 400 according to the inventive concept have a plurality of luminous flux control members which are arranged on a substrate in a matrix to disperse light uniformly. Since light with high intensity around the normal light axis is diffused uniformly by the luminous flux control member 100 or 200 according to the inventive concept and emitted upward, distance between the backlight unit and an optical film or a display can be minimized when the backlight unit according to the inventive concept.

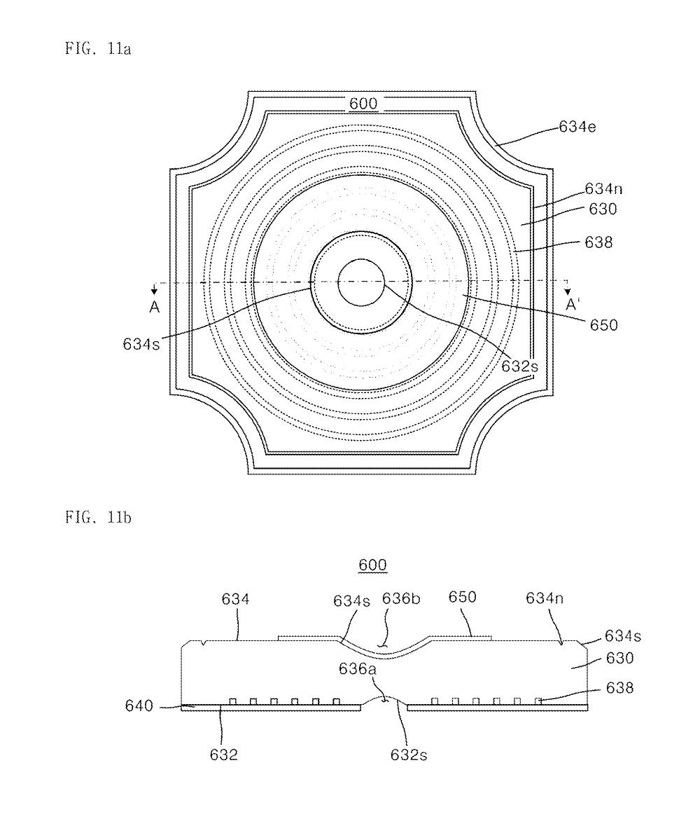

FIG. 11a is a plan view illustrating a luminous flux control member according to an embodiment of the inventive concept and FIG. 11b is a sectional view taken along a line A-A′ of FIG. 11a.

Referring to FIGS. 11a and 4b, the luminous flux control member 600 for a direct type backlight unit according to the inventive concept includes a light guide member 630 which has a first surface 632 with recessed light incident surface 32s on a normal light axis of a light emitting device 620 and a second surface 634 with a recess 636b on the normal light axis of the light emitting device 20 wherein the second surface is opposite to the first surface, and a light intensity adjusting sheet 650 which is formed at least on the second surface 634 around the recess 636b.

An incident concave 636a is formed on the first surface 632. The incident concave 36a is disposed at the light axis and around the light axis, and between the light emitting device and the first surface 632.

A sectional surface of the light incident surface 632s taken along the normal light axis may be parabolic shape or semicircular shape. In addition, the sectional surface has a shape of which tangent around the normal light axis is increasing to a negative direction as getting away from the normal light axis, the tangent around the normal light axis is increasing and decreasing to form a convex shape at the center of the incident concave 636a.

A plurality of luminous flux control patterns 638 is formed around the first surface. The luminous flux control patterns 638 are disposed around the normal light axis in a coaxial shape. A cross-section of the luminous flux control members 638 may be various shapes such as triangular groove, square groove, arc, arch, parabolic shape and so on. The light flux patterns 638 may not be limited to arrange in coaxial shape but has various shapes such as circular dot, rectangular dot, lattice, net, spiral or textile and so on.

The light guide member 630 may be formed of PMMA (Polymethyl Methacrylate) or PC (Polycarbonate).

For example, the light guide member 630 may be formed of PMMA or PC with at least 90% of transmittance measured by JIS K7361-1 measurement and less than 0.5% of haze measured by JIS K136 measurement.

In this embodiment, the light intensity adjusting sheet 650 is formed on the recess 636b and the first surface 634 around the recess 636b. The light intensity adjusting sheet 650 may be formed by being attached on the first surface 634 or coated by a paint or a resin. Edge of the light intensity adjusting sheet 650 may be wave shaped or saw-tooth shaped which is composed of curves or strait lines. The light intensity adjusting sheet 650 may be a semi-transparent material which can transmit a portion of light and may be a transparent matrix in which diffusing particles are dispersed or a transparent sheet which is white color.

In the above embodiments, an edge of the light guide member may have chamfer shape. For example, as shown in FIGS. 11a and 11b, the edge of light guide member 630 may have a chamfer surface 634e which is cut obliquely. An edge groove 634n may be formed at a distance from the edge of the light guide member. The edge groove 634n and the chamfer surface 634e are parts to increase the intensity of light which is emitted upward from a region far from the light source. In other words, the light emitted to the outside through the first surface 634 has high intensity because the incident angle at the center of the light guide member which is nearby the light source is small, but the incident angle of the light arrived at the region which is far from the light source is large such that the light emitted to the outside through the first surface 634 has low intensity. Therefore, the intensity of light emitted to the outside can be increased by forming the edge groove 634h at the first surface far from the light source, or by forming the chamfer surface 634e at the edge.

FIG. 12 is a drawing illustrating a luminous flux control member according to another embodiment of the inventive concept.

Referring to FIG. 12, as shown in FIG. 6, the luminous flux control member 700 according to the inventive concept may be a structure in which a luminous flux control member is disposed on a plurality of light emitting devices. For example, the structure may be four luminous flux control members 600 in FIGS. 8a and 8b which are coupled. However, it is not limited thereto, the luminous flux control member 700 according to the inventive concept may be a structure in which the variety numbers of the structures in FIGS. 8a and 8b such as two, three, six or eight are coupled, those are arranged in breadth and height as or in line as shown in FIG. 12.

As described above, the luminous flux control member 700 also may have an edge groove 734h which is formed at a distance from the edge of the luminous flux control member, and a chamfer surface may be formed at the edge.

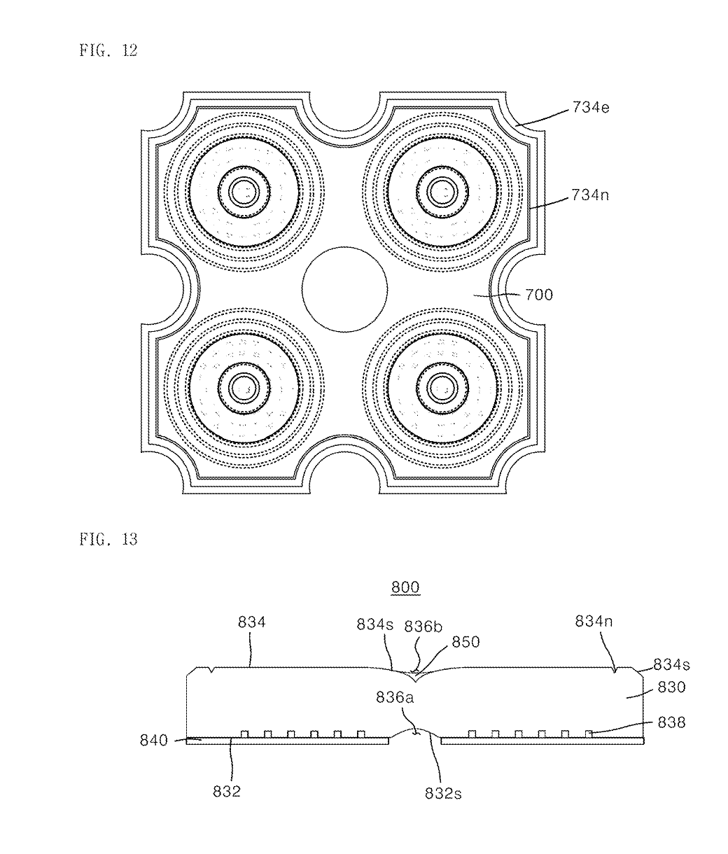

FIG. 13 is a drawing illustrating a luminous flux control member according to another embodiment of the inventive concept.

Referring to FIG. 13, a recess 836b of the luminous flux control member 800 may have a curved surface 834s of which tangent is increasing as approaching the center from an edge and the center is convergent to a light source.

Tangent of the curved surface 834s is large around the normal light axis. The tangent of the curved surface is lower as going to an edge. Thus, light around the normal light axis with high intensity has large incident angle on the basis of a normal line of the curved surface 834s such that probability of full reflection is high, and the incident angle is lower as going to an edgy such that the probability of the full reflection is lower. Therefore, the intensity of light around the normal light axis is dispersed such that the white spot can be suppressed. In order to uniformly disperse light which passes the recess 834b, a reflective coating layer 850 may be included on the curved surface 834s. The light intensity adjusting sheet 850 may be formed by being attached on the first surface 834 or coated by a paint or a resin.

As described above, the luminous flux control member 800 also may have an edge groove 834h which is formed at a distance from the edge of the luminous flux control member, and a chamfer surface 834e may be formed at the edge.

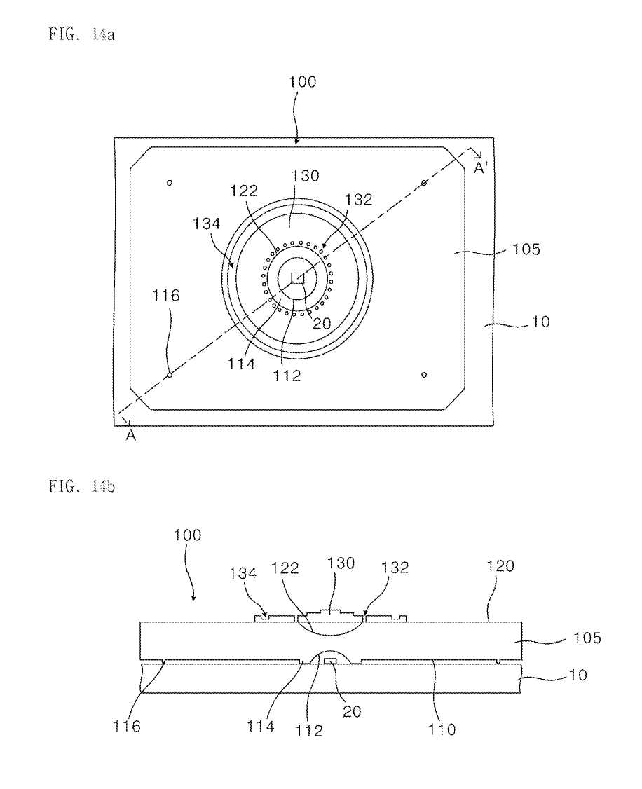

FIG. 14a is a plan view illustrating a luminous flux control member according to an embodiment of the inventive concept and FIG. 14b is a sectional view taken along a line A-A′ of FIG. 14a.

Referring to FIGS. 14a and 14b, a backlight unit according to the inventive concept includes a light source 20 disposed on a surface 10 and the luminous flux control member 100 according to the inventive concept which is disposed on the light source 20. The light source 20 may be a LED light source, and the LED light source may emit white light or blue light. The luminous flux control member 100 includes a first surface 110 and a second surface 120 opposite to the first surface 110. A recessed light receiving region 112 may be formed on the first surface 110 to correspond with the light axis of the light source 20. The light receiving region 112 may be formed at the first surface. A light guide ring 114 may be formed around the light recessed light receiving region to protrude from the first surface 110. The light guide ring 114 surrounds the light source 20 to guide light emitted from the light source into the light guide panel 105. A plurality of protrusions 116 may be formed on the first surface 110. The protrusion 116 may be acting to leave a predetermined space from the substrate 10 when the luminous flux control member 100 is disposed on the substrate 10, or be inserted in the holder (not shown) formed at the substrate 10 such that the luminous flux control member 100 can be accurately mounted on a desirable position. The light guide ring 114 may have protruded thickness which is the same and smaller.

A recess 122 may be formed on the second surface 120 to control the intensity of the light. The recess 122 may be formed at a position corresponding to the light axis of the light source 20 and the same as the light receiving region 122 in diameter. The recess 122 makes the light toward the second surface 120 nearby the light axis to be fully reflected or refracted at larger angle such that the intensity of the light penetrating the light guide panel 105 nearby the light axis is decreased.

The luminous flux control member 100 further includes a light adjusting sheet 130. The light intensity adjusting sheet 130 may be located at the center of the light guide panel 105, located on the light axis of the light source 20 and formed in correspondent with the recess 122. Although the intensity of the light nearby the light axis may be decreased by the recessed, the degree is not sufficient such that the light emitted from the second surface 120 is concentrated to the center of the light guide panel 105 and sharply decreased as getting away from the light axis. The light intensity adjusting sheet 130 diffuses the light emitted from the second surface 120 nearby the light axis or reflect the light to the first surface 110 thereby decreasing the intensity of the light nearby the light axis. The light reflected to the first surface 110 may be reflected off the first surface 110 again or penetrated through the first surface 110 and reflected off the substrate 10. The light emitted from the light source 20 can be uniformly diffused by repeating the refraction, diffusion, reflection and reflection again.

The light intensity adjusting sheet 130 may include a thick region and a thin region. Although, in order to clearly recognize a thickness difference, a stepped structure was shown in drawings, the light intensity adjusting sheet 130 actually may have continuous gradient of thickness without the clearly stepped structure. The light intensity adjusting sheet 130 may be designed to have thick part where the intensity of light emitted from the second surface 120 is high and a thin part where the intensity of the light is low. More specifically, a mean light intensity of the light emitted from the second surface is calculated and a lower central light intensity and an upper central light intensity are determined with the mean light intensity as a median, and then the light intensity adjusting sheet 130 may be formed thick on the second surface 120 where the light intensity is higher than the upper central light intensity and may be formed thin on the second surface 120 where the light intensity is emitted between the upper central light intensity and the lower central light intensity. The thickness of the light intensity adjusting sheet 130 may be adjusted in proportion to the intensity of the light after measuring intensity more than the lower central light intensity. In conventional, the light intensity adjusting sheet 130 may be designed to be thicker nearby the light axis and become lower as getting far from the light axis since the intensity of light nearby the light axis is high.

The light intensity adjusting sheet 130 may be formed of material with a refractive index higher than air such that an interface between the light intensity adjusting sheet 130 and the second surface 120 is higher than the second surface 120 in contact with air in a critical angle of the light incident from an interior of the light guide panel. Thus, the light can be emitted from the second surface 120 in contact with the light intensity adjusting sheet 130 even if the light cannot be emitted from the second surface 120 in contact with the air. If the thickness of the light intensity adjusting sheet 130 is formed to be lower at this part, the light emitted from the second surface 120 may be emitted to the outside without reflecting off the light intensity adjusting sheet 130.

In other words, a light extraction promoting region 134 which is thinner than the thin part of the light intensity adjusting sheet 130 may be disposed on the second surface 120 where the intensity of the light emitted from the second surface 120 is lower than the lower central light intensity, thereby increasing the intensity of the light emitted from the second surface 120. The light extraction promoting region 134 may be formed into thickness of 0.1 μm through 10 μm such that light emission efficiency can be increased. For example, the light extraction promoting region 134 may be formed into thickness about 5 μm.

The light extraction promoting region 134 may include diffusion particles which is higher than the light guide panel in the refractive index. In this case, the light arrived from the interior of the light guide panel to the interface between the light guide panel and the second surface 120 is refracted into the diffusion particles and diffused such that probability of outward emission can be raised.

The light intensity adjusting sheet 130 may be formed of white ink, dye, paint or resin. The light extraction promoting region 134 may be formed of the same material with other regions of the light intensity adjusting sheet 130, however, may be formed by mixing transparent ink, dye, paint or resin into the white ink, dye, paint or resin. Further, black or colored ink, dye, paint or resin may be further added or Ag paste may be added in the thick part of the light intensity adjusting sheet 130. Using these structures, a function of adjusting light intensity can be performed though the thick part of the light intensity adjusting sheet 130 is not excessively thick, the light emission efficiency can be raised although the thickness of the light extraction promoting region 134 is not lowered under process limitation.

Although the light extraction promoting region 134 is formed by the light intensity adjusting sheet 130 with thin thickness, the light emission efficiency can be obtained by forming a rough surface of the second surface 120 where the light extraction promoting region is formed or forming micro patterns without forming the light intensity adjusting sheet 130 on the light extraction promoting region.

A region where the intensity of the light is excessively lowered by the light intensity adjusting sheet 130 since the light intensity adjusting sheet 130 lowers the intensity of the light by diffusing or reflecting the light. In order to raise the intensity of light at this region, the light intensity adjusting sheet 130 may have a groove 132 by which a vicinity of the second surface 120 is exposed. For example, a border of the recess 122 may be curved shape such that light emission may be low. So, the light intensity adjusting sheet 130 may have a groove 132 by which a portion of the border of the recess 122. As shown in the drawing, the groove 132 may be a plurality of holes or slots, or may be other shapes.

FIG. 15 is a cross sectional view illustrating a light intensity adjusting sheet of the luminous flux control member according to an embodiment of the inventive concept.

Referring to FIG. 15, the light intensity adjusting sheet 130 may be formed on a release film 140 and attached on the light guide panel 105 after separating from the release film 140 or attached on the light guide panel 105 with the release film 140.

The light intensity adjusting sheet 130 may be formed into a plurality of layers in order to form the thick part, the thin part and the light extraction promoting region of the light intensity adjusting sheet 130. The plurality of the layers may be formed by stacking a plurality of layers or coating paint with predetermined thickness in several times.

As shown in a drawing, the first sheet layer 130 forming the light extraction promoting region is formed. The first sheet layer 130 may include a groove by which the release film 140 is exposed.

A second sheet layer 130b is formed on the first sheet layer 130a. The second sheet layer 130b may be formed on a region for forming the thin part of the light intensity adjusting sheet 130.

A third sheet layer 130c may be formed on the second sheet layer 130b, a fourth sheet layer 130d and more may be formed on a predetermined region of the third sheet layer 130c in accordance with necessity.

The first sheet layer 130a is a layer for forming the light extraction promoting region 134 and may further include diffusion particles which is higher than the light guide panel in refractive index.

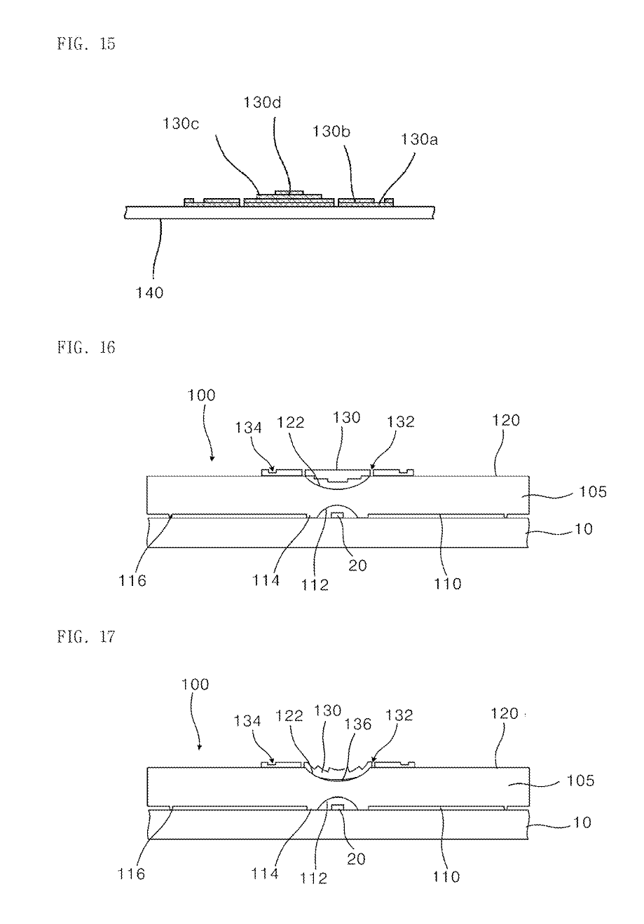

FIGS. 16 through 18 are sectional views illustrating the luminous flux control member according to another embodiment of the inventive concept.

Referring to FIG. 16, in the luminous flux control member 100 of the FIGS. 14a and 14b, the top surface of the light intensity adjusting sheet 130 has difference in height such that the thick part and the thin part are different in thickness, however, the luminous flux control member of this embodiment has a light intensity adjusting sheet of which the bottom surface has difference in protrusion to form difference between the thick part and the thin part.

The region where the intensity of the light emitted through the light guide panel 105 is high, for example the light intensity adjusting sheet 130 on the light axis and nearby the light axis is further protruded downward, and the region where the intensity of the light is low is less protruded than the region nearby the light axis.

The light extraction promoting region 134 is the same as the embodiment of FIG. 2 since the light extraction promoting region 134 is usually located on the second surface 120.

Referring to FIG. 17, in comparison that the light intensity adjusting sheet 130 of the FIGS. 14a, 14b and 16 is in contact with the second surface 120 with a space over the recess 122, the light intensity adjusting sheet 130 in this embodiment is formed on the second surface with being recessed on the recess 122. Being recessed on the recess 122, like the above embodiment, the light intensity adjusting sheet 130 may be formed thick on the region where the light intensity is higher than the upper central light intensity, be formed thin on the region where the light intensity is emitted between the upper central light intensity and the lower central light intensity, and be formed into the light extraction promoting region 134 where the light intensity is lower than the lower central light intensity.

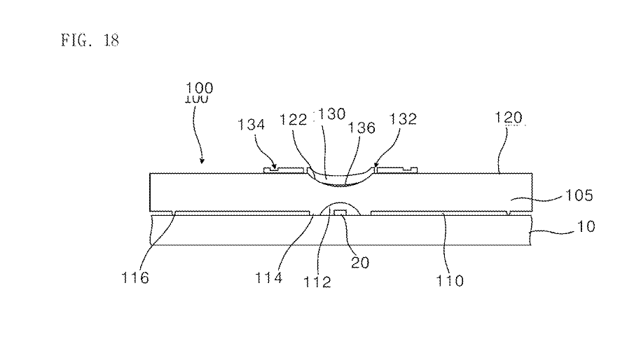

Although, in order to clearly recognize a thickness difference, a stepped structure was shown in FIG. 18, the light intensity adjusting sheet 130 actually may have continuous gradient of thickness without the clearly stepped structure.

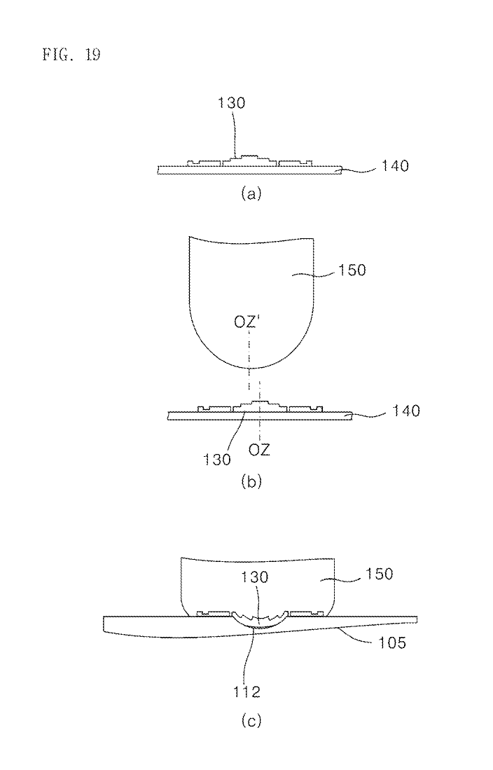

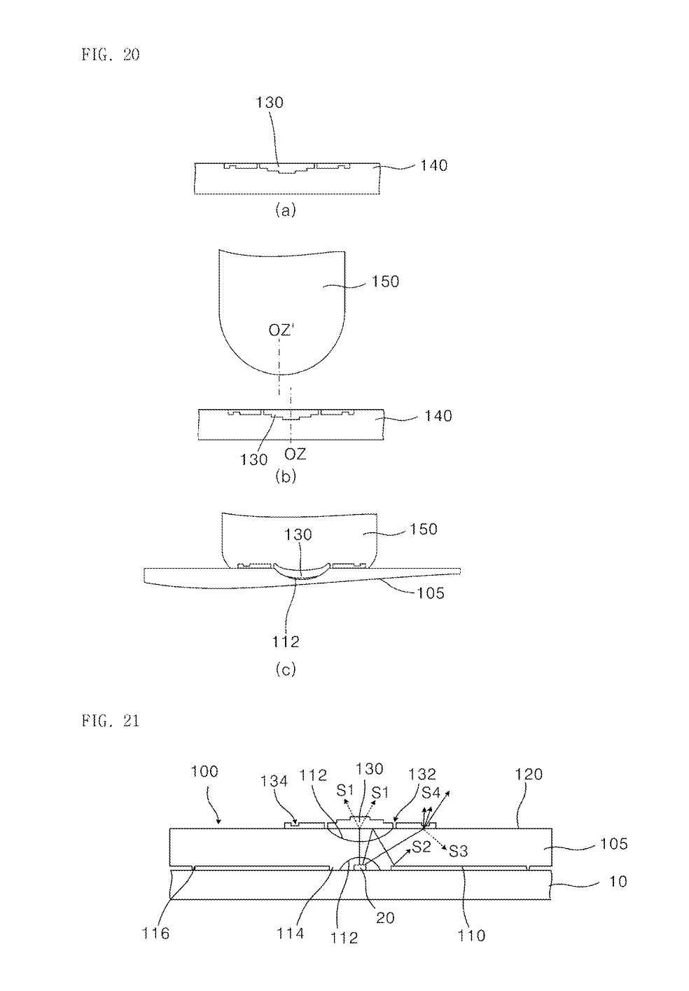

FIGS. 19 and 20 are drawings illustrating a method of fabricating a luminous flux control member of FIGS. 17 and 18.

Referring to FIG. 19, the light intensity adjusting sheet 130 which is formed on a release film is attached on the light guide panel to form the light intensity adjusting sheet 130, but a pad print, a stamp transcription or an imprint method is used to form the light intensity adjusting sheet in the recess 122.

Concretely, as shown in (a) of FIG. 19, the light intensity adjusting sheet 130 is formed on a base substrate 140. The light intensity adjusting sheet 130 may be formed by coating paint or resin, or by stacking films in several times.

Referring to (b) of FIG. 19, an elastic stamp 150 is located on the light intensity adjusting sheet 130. The stamp 150 may have a curved surface at an edge. The central axis OZ′ of the stamp 150 may be offset to the central axis OZ of the light intensity adjusting sheet 130

Referring to (c) of FIG. 19, the stamp 150 is separated from the base substrate 140 after pressing the stamp 150 on the light intensity adjusting sheet 130, the stamp on which the light intensity adjusting sheet 130 is attached is pressed on the second surface of the light guide panel 105 such that the light intensity adjusting sheet 130 is attached on the light guide panel 105. Since the stamp 150 has elasticity, the light intensity adjusting sheet 130 can be inserted in the recess region 122 of the light guide panel. In this time, the light intensity adjusting sheet 130 can be easily detached from the light intensity adjusting sheet 130 after attaching the light intensity adjusting sheet 130 by adjusting the central axis OZ′ of the stamp on a part offset to the center of the recess 122. Optionally, an air gap may be formed on the recess 122 under the light intensity adjusting sheet 130.

FIG. 20 is a drawing illustrating an embodiment which is different from FIG. 19.

Referring to (a) of FIG. 20, the light intensity adjusting sheet 130 may be printed on an etched substrate 140. The etched substrate 140 has an intaglio pattern corresponding to the light intensity adjusting sheet 130. A material of light intensity adjusting sheet is coated on the etched substrate 140 and the material excepting on the intaglio pattern is removed to remain the light intensity adjusting sheet 130 in the intaglio pattern.

In the same way as FIG. 19, the light intensity adjusting sheet 130 is separated from the etched substrate 140 by using the stamp to form the light intensity adjusting sheet 130 on the light guide panel 150.

FIG. 21 is a drawing illustrating luminous flux control of the luminous flux control member according to an embodiment of the inventive concept.

Referring to FIG. 21, light emitted from the light source 20 travels in the light guide panel and arrives on the light intensity adjusting sheet 130. The light nearby the light axis is emitted to the thick part and the thin part of the light intensity adjusting sheet 130, diffused in the light intensity adjusting sheet 130 and diffused at a wide angle (S1) or reflected into the light guide panel 105 (S2). The light extraction promoting region 134 may be formed on a part where the intensity of light emission caused by reflection of the light emitted from the light source 20 (S3) such that the light arrived on the second surface 120 where the light extraction promoting region 134 is formed is radiated to the outside without reflection by the light extraction promoting region 134.

FIG. 22 is a drawing illustrating a luminous flux control member according to another embodiment of the inventive concept.

Referring to FIG. 22, the luminous flux control patterns 738 according to the inventive concept may become larger from the center to the edge. For example, the luminous flux control patterns 738 may have increasing height with the same width, increasing width with the same height, increasing height and width, increasing or decreasing intervals with the same magnitude as getting to the edge. This can be applied even if the sectional surface of the luminous flux control pattern 738 is not limited to rectangular shape but modified into such as arc shape, triangular wave shape and so on.

Although the drawings of the inventive concept show that the length and breadth of the luminous flux control member is the same, the length and the breadth of the luminous flux control member may be different. For example, the ratio of the length and the breadth may be 16:9 if the radio of display dimensions is 16:9. However, the ratio of the length and the breadth of the luminous flux control member is not always the same but the ratio can be selected free.

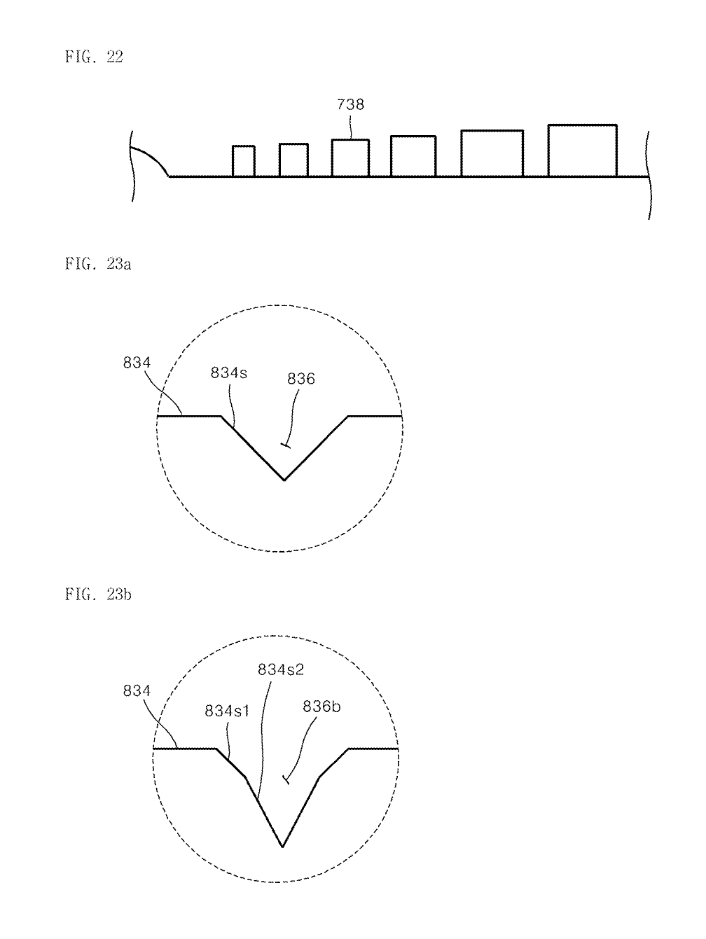

FIGS. 23a and 23b are drawings illustrating modified embodiments of a recess of a second surface of a luminous flux control member according to embodiments of the inventive concept.

Referring to FIG. 23a, although the recess of the second surface are suggested in the variety of shapes in the above embodiment, the light reflective surface 834e of the second surface 834 may be formed into cone shaped recess 836b as another embodiment. That is to say, the sectional shape of the recess 836b is triangular shape, and the light reflective surface 834s may have an axis symmetrical structure in the basis of the light axis.

Referring to FIG. 23b, the recess 836b is a double stepped structure which has a cone shaped recess in the center of the cone shaped recess. In other words, it includes a recess 836b which is formed by a first light reflective surface 834s1 having a predetermined angle in the basis of the first surface 834 and a second light reflective surface 834s2 connecting with the first light reflective surface 834s1 and having an angle larger than the first light reflective surface 834s1 in the basis of the second surface 834. The first light reflective surface 834s1 and the second light reflective surface 834s2 may have an axis symmetrical structure in the basis of the light axis.

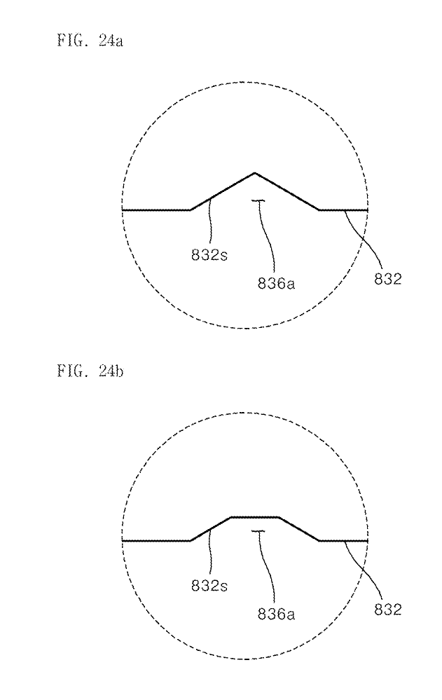

FIGS. 24a and 24b are drawings illustrating modified embodiments of a concave of a luminous flux control member according to embodiments of the inventive concept.

Referring to FIG. 24a, the first surface 832 has a concave 836a between the first light incident surface 832s and the light source. The sectional surface of the light incident surface 832s in the above embodiments are curved surfaces, however, this embodiment has a linear sectional surface. In other words, the concave 836a has a cone shaped recess structure which is axis symmetric in the basis of the light axis.

Referring to FIG. 24b, the concave 836a as the light incident surface 832s of the first surface 832 may have a sectional surface of trapezoidal shape. In other words, the concave 836a in this modified embodiment may have recessed structure of truncated cone shape which is axis symmetric in the basis of the light axis.

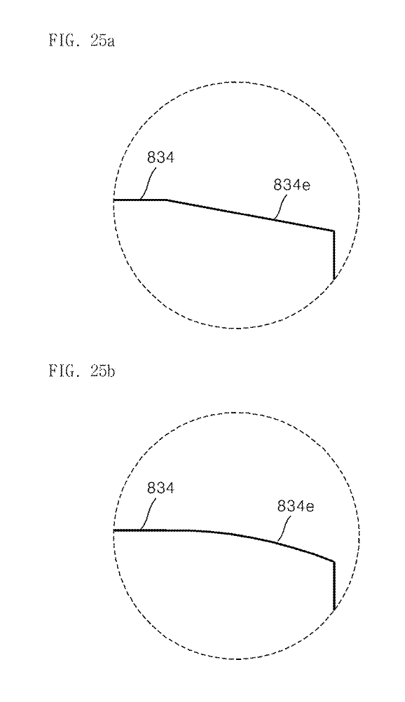

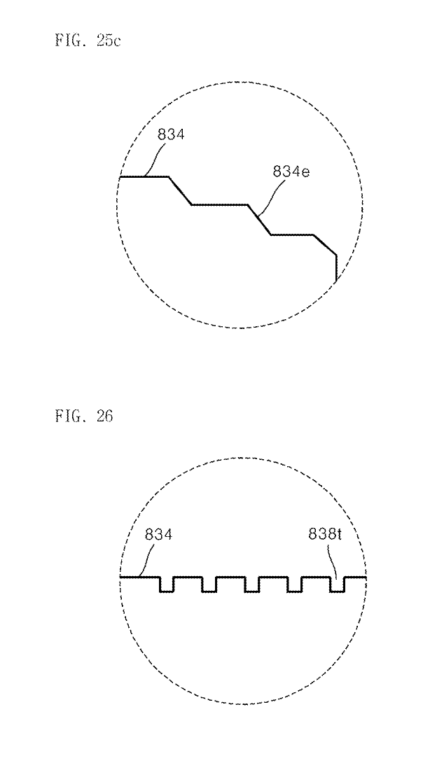

FIGS. 25a through 25c are drawings illustrating modified embodiments of a board region of a luminous flux control member according to embodiments of the inventive concept.

As described in reference with FIGS. 11a, 11b, 12 and 13, the luminous flux control member according to the inventive concept may have a chamfer surface at an edge.

Referring to FIG. 25a, the chamfer surface 834e may be modified from the above embodiment to be formed more gently and extended to the center of the second surface 834.

Referring to FIG. 25b, the chamfer surface 834e may be processed into a curved sectional surface such that the slop may be gentled as approaching to the center of the luminous flux control member.

Referring to FIG. 25c, the chamfer surface 834e may be formed into stepped shape.

FIG. 26 is a drawing illustrating a second surface of a luminous flux control member according to another embodiment of the inventive concept.

Referring to FIG. 26, a plurality of luminous flux control patterns 838t is formed on the second surface. The luminous flux control patterns 838t are disposed around the normal light axis in a coaxial shape. A cross-section of the luminous flux control members 838t may be various shapes such as triangular groove, square groove, arc, arch, and parabola and so on. The light flux patterns 838t may not be limited to arrange in coaxial shape but has various shapes such as circular dot, rectangular dot, lattice, net, spiral or textile and so on. The upper luminous flux control patterns 838t may be disposed in corresponding to the luminous flux control patterns of the first surface or offset with each other.

According to the inventive concept, the light emitted to a region adjacent to the normal light axis is reflected into the luminous flux control member and emitted through a peripheral emitting region such that the light of the light source can be spread and maximum intensity of light is disperse to prevent from the white spot.

According to the inventive concept, at least a portion of the light emitted from the luminous flux control member is reflected and the light emitted from a plurality of light sources is uniformly spread such that the light spread to adjacent light control member is prevented or reduced.

What is claimed is:

1. A luminous flux control member comprising:
a light guide member which has a first surface with recessed light incident surface on a normal light axis of a light emitting device and a second surface with a recess on the normal light axis of the light emitting device and opposite to the first surface; and
a light intensity adjusting sheet which is formed on the second surface around the recess, wherein the recess comprises both sides and a planar surface between the both sides in a sectional view along the normal light axis.

2. The luminous flux control member of claim 1, wherein the light intensity adjusting sheet covers on the recess and a vicinity of the recess.

3. The luminous flux control member of claim 1, wherein in a sectional view along the normal light axis, the recess comprises a center where tangent is 0 and a curved surface where tangent is increasing as getting away from the center.

4. The luminous flux control member of claim 1, in a sectional view along the normal light axis, wherein the recess comprises a curved surface where tangent is increasing as approaching to the center from a border thereby converging to the light source.

5. The luminous flux control member of claim 3, further comprising:
a reflect coating layer formed on the recess, wherein the light intensity adjusting sheet is formed on the second surface around the recess to expose the recess.

6. The luminous flux control member of claim 3, wherein the recess comprises,
a first recess with a center where tangent is 0 and a curved surface where tangent is increasing as getting away from the center;
a horizontal surface around the first recess;
a stepped surface in the border of the horizontal surface; and
a second recess with a curved surface where tangent is increasing as getting away from the stepped surface.

7. The luminous flux control member of claim 6, further comprising:
a reflect coating layer formed on the first recess, wherein the light intensity adjusting sheet is formed on the second surface around the recess and the second recess and the horizontal surface to expose the first recess.

8. The luminous flux control member of claim 1, wherein the light intensity adjusting sheet transmits a portion of the light incident to the second surface after passing the incident surface and reflect a portion of the light incident to the second surface after passing the incident surface to the first surface.

9. The luminous flux control member of claim 1, further comprising:
a shade layer formed on a side of the light guide member.

10. The luminous flux control member of claim 1, wherein the light intensity adjusting sheet comprises:
a thick region and a thin region which reduce intensity of light emitted from the second surface, and
a light extraction promoting region thinner than the thin layer which increases intensity of light emitted from the second surface.

11. The luminous flux control member of claim 1, wherein the thick region of the light intensity adjusting sheet is located over the center of the recess.

12. The luminous flux control member of claim 1, wherein the luminous flux control member of the light intensity adjusting sheet is located on the second surface away from the recess at a predetermined distance.

13. The luminous flux control member of claim 1, when the light source is disposed under the light receiving region for locating centers of the light receiving region and the recess close to the light axis, wherein the thick region and thin region of the light intensity adjusting sheet is disposed on the second region where light with intensity higher than a lower central light intensity is emitted from the light guide panel, and the light extraction promoting region is located on the second region where light with intensity lower than a lower central light intensity is emitted from the light guide panel.

14. The luminous flux control member of claim 13, wherein the light intensity adjusting sheet further comprises an opening exposing a vicinity of the recess.

15. A backlight unit comprising:
a substrate where a plurality of light emitting devices is disposed;
a plurality of luminous flux control members which are disposed on the substrate corresponding to the light emitting devices such that the light from the light source is uniformly transmitted upward; and
a shade layer which is disposed between the luminous flux control members to reflect a portion of the light emitted through the luminous flux control member.

16. The backlight unit of claim 15, wherein the shade layer is a partition which is disposed on the substrate to form a plurality of domains, and the luminous flux control members are disposed in the domains, respectively.

17. The backlight unit of claim 15, wherein the luminous flux control member includes a light guide member through which light emitted from the light emit device is transmitted, and the shade layer is formed on a side of the luminous flux control member.

18. The backlight unit of claim 15, wherein the shade layer comprises,
a light reflective region where the light emitted from the luminous flux control member is reflected; and
a transparent region where the light emitted from the luminous flux control member is transmitted to an adjacent luminous flux control member.

19. The backlight unit of claim 15, wherein the shade layer is semi-transparent which reflects a portion of the light emitted from the luminous flux control member and transmits a portion of the light emitted from the luminous flux control member.
